(19) United States
(12) Patent Application Publication
(10) Pub. No.: US 2005/0057480 A1
(43) Pub. Date: Mar. 17, 2005

(54) Gate driving circuit of LCD

(76) Inventors: Mu-Shan Liao, Changhua County (TW); Wen-Tse Tseng, Taoyuan County (TW); Juin-Ying Huang, Taoyuan County (TW); Ming-Wei Tsai, Taoyuan County (TW)

Correspondence Address: BIRCH STEWART KOLASCH & BIRCH, PO BOX 747, FALLS CHURCH, VA, 22040-0747, US

(21) Appl. No.: 10/778,233

(22) Filed: Feb. 17, 2004

(30) Foreign Application Priority Data
Aug. 28, 2003 (TW) 092123832

(51) Int. Cl. G09G 3/36

(52) U.S. Cl. 345/98

(57) ABSTRACT

A gate driving circuit of a LCD comprises a plurality of drivers, a timing processor, a trigger signal processor, a delay unit, and a logic unit for producing an output enable signal. Further, transferring the signal to the gate driver of a LCD can efficiently control the charging time of each region in the LCD. The main object of the gate driving circuit of a LCD is that block dim phenomenon in each light crystal region will be restrain, and the visualization of the LCD can be enhanced.

### BACKGROUND OF THE INVENTION

1. Field of the Invention

The present invention relates to a driving circuit in Liquid Crystal Display (hereinafter referred to as “LCD”). More particularly to a gate driving circuit of LCD.

2. Description of the Related Art

Numerous attempts have been made to construct a commercially practical liquid crystal display (LCD). It is often seen that LCD comprises multiple transistors with an array mode formed on a LCD panel. One side of LCD panel has multiple gate drivers for controlling Thin-Film Transistor's (TFT) switch, wherein called the scan-line. The neighboring side of the gate driver has multiple source drivers. This will make the display data be transferred once the gate driver switches on the thin-film transistor, wherein called the data line. The problem existing in present use is block dim phenomenon happened in certain frames. This is caused from the coupling capacity effect existing between the data line and the scan line in the gate side once the Thin-Film Transistor switches off. The return current is also produced by different impedances between the wiring impedance and each COF's (Chip On Film) inner impedance. This will lead to produce voltage drop. In other words, the different voltage drops will be produced in the gate off-state voltages (VGL, the off-state voltage of the thin-film transistor is about −6V) of each gate driver.

The return current (I_{Rn}) of the nth scan line is equal to Cdv/dt. C herein is the coupling capacity between data line and the scan-line, dv herein is the voltage burden between the data-line voltage and the TFT off-state voltage, and dt is various time of a scan-line. In the black-white frame, the value of dv is the maximum, and, therefore the maximum return current is produced. Besides, the voltage burden of the gate off-state voltage in each gate driver reaches at maximum. As a result, it has different effects in each region of the gate driver, and the different luminance is happened in each gate driver. In other words, block dim phenomenon is happened in each gate driver.

For example, while resolution XGA is 1024*768, the return current (I_{Rn}) is equal to Cdv/dt (I_{Rn}=Cdv/dt), and the time (dt) is about 20 μs, the C generally is 15˜25 farad. For XGA resolution, a LCD panel has 3*1024 data lines and 768 scan lines in total. However, there is only one scan line away from on-state, and the other 767 scan lines are at off-state. The total return current (I_{R}) herein is 3*1024*767*I_{R}n, which is about 3˜9 mA. The impedance is transferred by each power wiring in the LCD panel. General Speaking, the first gate driver has a resistance (R_{P}), which is about 10˜76 ohm. The second gate driver has a double resistance ((R_{P}), and the third gate driver has a triple resistance (R_{P}). The return current produces three voltage drops in the three impedances of the panel, and the voltage changes of in the three gate drivers are ΔV_{GD1}=300 mV, ΔV_{GD2}=600 mV, and ΔV_{GD3}=−900 mV (I_{R}n=6 mA, R_{P}=50 ohm), as shown in FIG. 1.

Furthermore, each gate driver has different off-state voltage (V_{GL}). As shown in FIG. 2, V_{GL1}<V_{GL2}<V_{GL3}. The parasitic capacity is existed between the gate and the drain in the thin-film transistor, and therefore, the voltage of the gate side (scan line) will affect the voltage of the drain side (liquid crystal region). In other words, the different voltages of the gate side (V_{GL1},V_{GL2} and V_{GL3}) have different levels of effects in the charging voltages of the liquid crystal regions. Similarly, the minimum voltage (V_{GL1}) has the biggest effect in the liquid crystal region of the first gate driver. Therefore, the liquid crystal in this region has the biggest voltage leakage caused of V_{GL1}. In contrast, the liquid crystal region of the third gate driver has the smallest voltage leakage caused of V_{GL3}. According to the above description, the block dim phenomenon happened in the gate driver of a LCD panel is mainly caused from the different luminance in each gate driver. The different luminance is caused from different charging voltage in liquid crystal regions. In other words, it can be that each gate driver has different V_{GL} thereto the effect.

The present invention, therefore, is to provide a gate driving circuit of LCD to overcome the above problems. More, it overcomes the shortage of the block dim phenomenon happening in the liquid crystal regions of each gate driver, which is caused from different gate off-state voltages in each gate driver. The visualization in a LCD is also enhanced.

### SUMMARY OF THE INVENTION

It is an object of the present invention to provide a gate driving circuit of a LCD using the simple circuit to control the charging time in each liquid crystal region of each gate driver. The block dim phenomenon in each light crystal region will not be happened, and the visualization of the LCD, therefore is enhanced as well as reducing the manufacturing cost.

In order to achieve the above purpose, the present invention is to provide a gate driving circuit of a LCD. By producing an output enable signal to the multiple gate drivers of a LCD, it can control the charging time of each region corresponding to the gate driver. The driving circuit comprising: A timing generator producing a gate clock signal and a gate initial signal; A trigger signal generator receiving the gate clock signal and the gate initial signal to produce the initial trigger signal of the gate driver thereto a delay unit; A delay unit receiving the initial trigger signal, the gate clock signal, and a gate off-state voltage of the gate driver to produce a delay clock signal thereto a logic unit; A logic unit includes an EX-OR gate and a AND gate. The EX-OR Gate receives a delay clock signal and the gate clock signal of the timing generator to produce a first signal thereto the AND gate. The AND gate receives the first signal and the gate clock signal of the timing generator to produce a output enable signal, and also transfer it to the gate driver for controlling the charging time of each liquid crystal region corresponding to the gate driver.

### BRIEF DESCRIPTION OF THE DRAWINGS

For a more complete understanding of the present invention and for further advantages thereof, reference is now made to the following description taken in conjunction with the accompanying drawing, in which:

FIG. 1 shows the voltage change of the gate driver according to the present invention;

FIG. 2 shows the off-state voltage waveform of the gate driver according to the present invention;

FIG. 3 shows circuit according to the present invention; and

FIG. 4 is a timing graph showing the output enable signal according to FIG. 3.

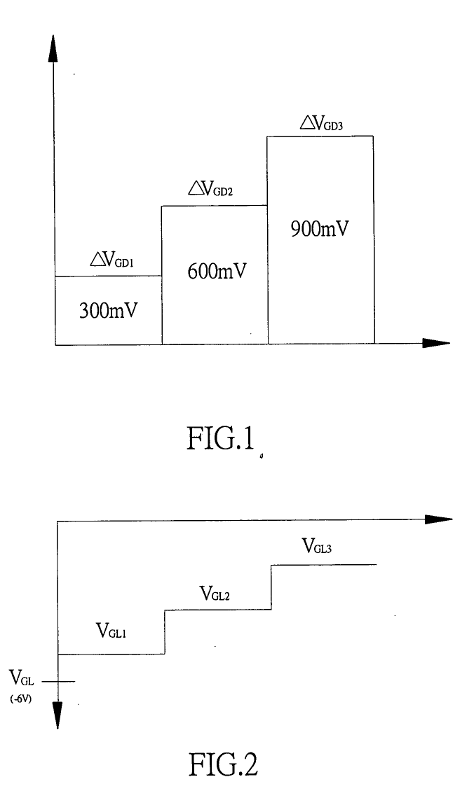

### DETAILED DESCRIPTION OF THE PREFERRED EMBODIMENTS

The present invention relates to a gate driving circuit of a LCD. More particularly, the driving circuit is using to control the charging time in each liquid crystal region corresponding to the multiple gate drivers of a LCD. Further, it performs feedback motion by different gate voltages of each gate driver to produce different output enable signals of the pulse length. This can adequately control the pulse length of the output enable signal, and further control the charging time in each liquid crystal region corresponding to the gate driver. As a result, the block dim phenomenon in liquid crystal regions can be avoided.

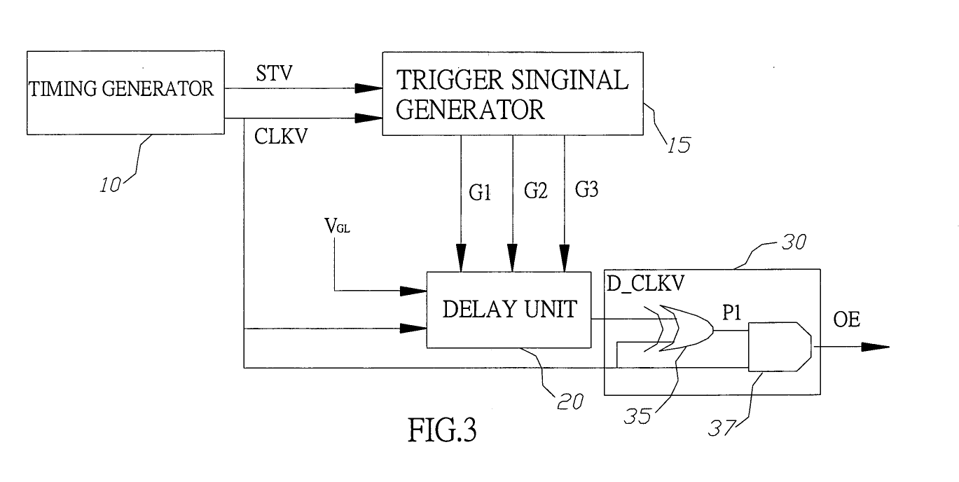

Referring to FIG. 3, it is one preferred block diagram showing circuit according to the present invention. As shown in the figure, it comprises a timing generator 10, which produces a gate clock signal (CLKV), and a gate initial signal (STV). The two signals are transferred to a trigger signal generator 15 at the same time for producing the initial trigger signals (G1, G2, and G3) of each gate driver. Then, they are transferred to a delay unit 20 in proper order. The delay unit 20 not only receives trigger signals (G1, G2, or G3) but also receives the output gate clock signal (CLKV) from the timing generator 10 and the gate off-state voltage (V_{GL}) from the gate driver for producing and outputting a delay clock signal (D_CLKV). The delay clock signal (D_CLKV) is transferred to a logic unit 30. The delay unit 20 further includes a comparator and a referenced voltage. The comparator receives the gate off-state voltage (V_{GL}) of the gate driver and then processes comparison with the referenced voltage for producing the delay clock signal (D_CLKV). The gate off-state voltage (V_{GL}) passes through a noise filter before transferring to the delay unit 20.

The logic unit 30 comprises an EX-OR gate 35 and a AND gate 37. The EX-OR gate receives a delay clock signal (D_CLKV) and the gate clock signal (CLKV) of the timing generator 10 to produce a first signal (P1). Also, the first signal (P1) is transferred to the AND gate 37. The AND gate 37 receives the first signal (P1) and the gate clock signal (CLKV) of the timing generator 10 to produce a output enable signal (OE), and also transfer it to the gate driver.

The delay clock signal (D_CLKV) of the above delay unit 20 is corresponding to the initial trigger signal of each gate driver. In other words, while the delay unit receives the initial trigger signal (G1), it means the initial trigger signal (G1) is the initial trigger signal (G1) of the first gate driver. The received gate off-state voltage (V_{GL}) here is the gate off-state voltage (V_{GL}) of the first gate driver. The produced delay clock signal (D_CLKV) here is processed from the comparison between the gate off-state voltage (V_{GL}) of the first gate driver and the referenced voltage. The produced output enable signal is transferred to the first gate driver. As a result, while the delay unit 20 receiving the initial trigger signals (G2 and G3), it means that the received delay clock signal (D_CLKV) is processed from the comparison between the gate off-state voltage of the second gate driver and the gate off-state voltage of the third gate driver. Further, the received output enable signals individually are transferred to the second gate driver and the third gate driver thereto control the charging time in the liquid crystal regions of the second and the third gate drivers.

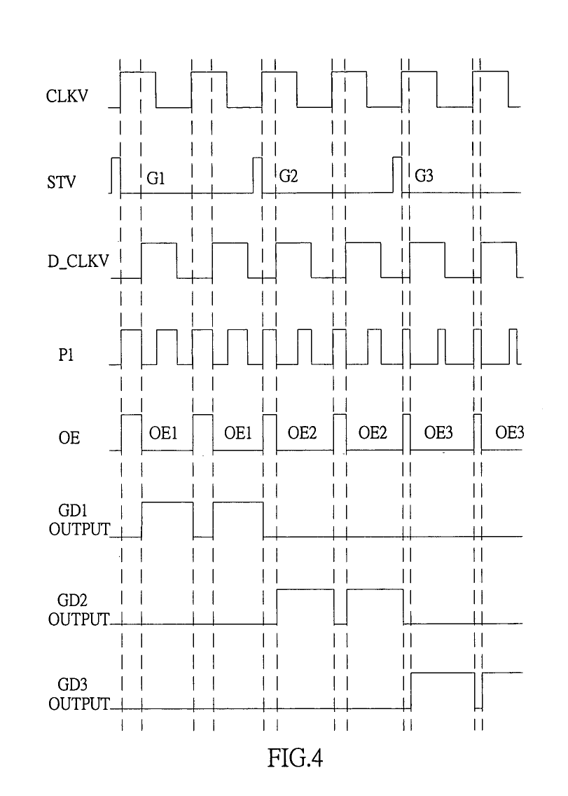

Referring to FIG. 4, it is one preferred timing graph showing the output enable signal according to FIG. 3. As shown in the figure, the gate clock signal (CLKV) is a cycling square-wave signal. The delay clock signal (D_CLKV) is that the delay unit 20 is processed from a comparison algorism between the received initial trigger signal and the gate off-state voltage (V_{GL}) of the corresponding gate driver. The delay signal (D_CLKV) varies by the gate off-state voltage (V_{GL}) of the gate driver. The first signal (P1) is produced while the delay clock signal (D_CLKV) and the gate clock signal (CLKV) passing through an EX-OR gate algorism. The output enable signal (OE) is produced while the first signal (P1) and the gate clock signal processing through a AND gate algorism. OE1, OE2, and OE3 as shown in the figure are corresponding to the output enable signals of the initial triggers (G1, G2, and G3) in the first, the second and the third gate drivers. GD1 output signal, GD2 output signal, and GD3 output signal are the output signal waveforms while the initial trigger signals (OE1 OE2 and OE3) individually outputting to the first, the second, and the third gate drivers.

According to the above description, the present invention relates to a gate driving circuit of a LCD. It performs a feedback motion by different gate off-state voltages to produce different output enable signals of the pulse length according to each gate driver. This, therefore, can control the charging time of each liquid crystal region corresponding to the gate driver for avoiding block dim phenomenon happened in the liquid crystal region.

Although the present invention has been described in detail with respect to alternate embodiments, various changes and modifications may be suggested to one skilled in the art, and it should be understood that various changes, suggestions, and alternations can be made hereto without departing from the spirit and scope of the invention as defined by the appended claims.

1. A gate driving circuit of a LCD, comprising:
a plurality of gate drivers;
a timing generator producing a gate clock signal and a gate clock signal and a gate initial signal;
a trigger signal generator receiving the gate clock signal and the gate initial signal to produce the initial trigger signal of the gate driver;
a delay unit receiving the initial trigger signal, the gate clock signal, and a gate off-state voltage of the gate driver to produce a delay clock signal; and
a logic unit receiving the delay clock signal and the gate clock signal to produce an output enable signal for controlling the charging time in each liquid crystal region of the gate drivers.

2. The gate driving circuit of a LCD according to claim 1, wherein the logic unit comprises an Exclusive-OR gate (XOR gate) and a AND gate, and the XOR gate receiving the delay clock signal and the gate clock signal produces a first signal and then transfers to the AND gate, and the AND gate receiving the first signal and the gate clock signal produces the output enable signal.

3. The gate driving circuit of a LCD according to claim 1, wherein the delay unit comprises a comparator and a referenced voltage, and the comparator receives the off-state voltage and then does comparison with the referenced voltage.

4. The gate driving circuit of a LCD according to claim 1, wherein the output enable signal transfers to the gate driver.

5. The gate driving circuit of a LCD according to claim 1, wherein the gate off-state voltage passes through noise filter before transferring to the delay unit.
